(19) United States
(12) Patent Application Publication
(10) Pub. No.: US 2002/0126437 A1
(43) Pub. Date: Sep. 12, 2002

(54) Electrostatic chuck system and method for maintaining the same

(75) Inventor: Fu-Sheng Chen, Hsinchu (TW)

Correspondence Address: FINNEGAN, HENDERSON, FARABOW, GARRETT &, DUNNER LLP, 1300 I STREET, NW, WASHINGTON, DC, 20005, US

(73) Assignee: Winbond Electronics Corporation

(21) Appl. No.: 09/802,924

(22) Filed: Mar. 12, 2001

(51) Int. Cl. H02N 13/00

(52) U.S. Cl. 361/234; 279/128

(57) ABSTRACT

A chuck system for supporting a semiconductor wafer that includes a chuck platform for supporting the semiconductor wafer, and a lift structure movably coupled with the chuck platform to receive the semiconductor wafer that includes a lift base, and at least one lift pin removably coupled with the lift base, the lift pin having two ends with a first end removably coupled to the lift base and a second end for supporting the semiconductor wafer during lifting operation of the lift structure.

### BACKGROUND OF THE INVENTION

1. Field of the Invention

This invention pertains in general to an electrostatic chuck system, and more particularly, to an electrostatic chuck system used in a semiconductor fabrication process and a method of maintaining the system.

2. Description of the Related Art

An electrostatic chuck system is used in a semiconductor manufacturing process to hold a semiconductor wafer on a platform during various steps of the manufacturing process by employing an electrostatic force by either placing opposite charges on the wafer and platform or placing charges on either the wafer or platform. An electrostatic chuck system is different from a known mechanical chuck system in that an electrostatic chuck system does not create direct contact with the device side of a semiconductor wafer. A chuck system in general operates either to hold a semiconductor wafer in place during processing or transport the wafer from one equipment to another. The stability of a chuck system promotes uniformity of wafer processing.

U.S. Pat. No. 5,815,366 to Morita et al, describes a known electrostatic chuck system. FIG. 1 illustrates an electrostatic system similar to that described in Morita et al. Referring to FIG. 1, a chuck system 50 for supporting a semiconductor wafer 10 includes a platform 12 that provides support to the non-device side of wafer 10 and a processing chamber 60, which may be a plasma processing system. Chuck system 50 additionally includes a lift structure 14 coupled to a drive mechanism 16 and movably coupled with platform 10. Lift structure 14 operates primarily to serve two purposes. First, when a wafer transferring mechanism (not shown), such as a robotic arm, brings wafer 10 into processing chamber 60 to a position far above platform 12, as shown in FIG. 2a, lift structure 14 moves upward to receive wafer 10. After wafer 10 is received, lift structure 14 lowers and places wafer 10 on platform 12, as shown in FIG. 2b. Second, when processing chamber 60 shown in FIG. 1 completes processing wafer 10, lift structure 14 moves upward to lift wafer 10 away from platform 12 to a position shown in FIG. 2a. The wafer transferring mechanism then enters chamber 60 to receive wafer 10. Lift structure 14 then lowers itself, and thereby places wafer 10 on the transferring mechanism.

FIGS. 3a and 3b illustrate two types of lift structures. Referring to FIG. 3a, lift structure 14a includes a disc-shaped lift base 20a having a mounting hole 22a to couple to driving mechanism 16 shown in FIG. 1. Lift structure 14a also includes a plurality of lift pins 24a integrally formed with lift base 20a. Referring to FIG. 3b, a lift structure 14b includes a rectangular-shaped lift base 20b and a plurality of mounting holes 22b to mount lift structure 14b to driving mechanism 16 shown in FIG. 1. Lift structure 14b also includes a plurality of lift pins 24b integrally formed with lift base 20b.

As described above, a traditional lift structure is formed as a single, integral structure with metal or alloy. A lift structure may also be made of steel and has lift pins welded to a lift base. The lift structure, after numerous repeated operations under various harsh temperatures and atmospheric pressures in a processing chamber such as one shown in FIG. 1, often becomes defective due to deformation of one or more of the plurality of lift pins. The entire lift structure will then need to be replaced. Indeed, a lift structure may need to be maintained and replaced on regular intervals before the lift pins are actually deformed to ensure that wafers are not mis-processed. Any maintenance or repair causes a manufacturing equipment to be unavailable during the manufacturing process and therefore adversely impacts on the productivity of the equipment. In addition, any interruption to a semiconductor manufacturing process often decreases the productivity of an entire product line.

However, the repair and maintenance of traditional lift structures involve a complicated procedure. Referring to FIG. 1, electrostatic chuck system 50 also includes a cooling system and control system (not shown) under platform 12. The replacement procedure involves removing the liquid circulating in chuck system 50 and several other components of chuck system 50. The whole process is time-consuming, which means chuck system 50 will be unavailable for production for an extended period of time.

### SUMMARY OF THE INVENTION

Accordingly, the present invention is directed to a chuck system that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structures and methods particularly pointed out in the written description and claims thereof, as well as the appended drawings.

To achieve these and other advantages, and in accordance with the purpose of the invention as embodied and broadly described, the present invention provides a chuck system for supporting a semiconductor wafer that includes a chuck platform for supporting the semiconductor wafer, and a lift structure movably coupled with the chuck platform to receive the semiconductor wafer that includes a lift base, and at least one lift pin removably coupled with the lift base, the lift pin having two ends with a first end removably coupled to the lift base and a second end for supporting the semiconductor wafer during lifting operation of the lift structure.

In one aspect of the invention, the first end of the lift pin is threaded and the lift base having a threaded hole for receiving the first end of the lift pin.

In another aspect of the invention, the chuck system further includes a bolt, wherein the first end of the lift pin is threaded and the bolt removably couples the lift pin with the lift base through an opening provided by the lift base.

Also in accordance with the present invention, there is provided a chuck system for supporting a semiconductor wafer that includes a chuck platform for providing support of the semiconductor wafer, and a lift structure movably coupled with the chuck platform for supporting the semiconductor wafer to receive or place the semiconductor wafer on the chuck platform or to lift the wafer away from the chuck platform, the lift structure includes a lift pin, and a lift base for supporting the lift pin, wherein the lift pin has two ends, the lift pin being removably coupled with the lift base, a first end of the lift pin being connected with the lift base, and a second end of the lift pin supporting the semiconductor wafer during lifting or placing operation of the lift structure, and wherein the lift structure has an external thread on the first end of the lift pin and a matching internal thread in a hole provided by the lift base to removably couple the lift pin and the lift base.

Additionally in accordance with the present invention, there is provided a method of maintaining a lift structure of a chuck system that supports a semiconductor wafer that includes providing a removable first lift pin to a lift base in the lift structure, removing the first lift pin from the lift base with the lift structure being coupled to the chuck system, and mounting a second lift pin to the lift base with the lift structure being coupled to the chuck system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings:

FIG. 1 illustrates a known electrostatic chuck system;

FIG. 2a illustrates a known electrostatic chuck system in operation;

FIG. 2b illustrates a known electrostatic chuck system in operation;

FIG. 3a illustrates a known lift base that has a mounting hole in its center;

FIG. 3b illustrates a known lift base that has a plurality of mounting holes;

FIG. 4 illustrates a chuck system of the present invention;

FIG. 5 illustrates a lift structure of the present invention;

FIG. 6 illustrates a lift structure of the present invention having a lift pin with an external thread and a bolt for coupling the lift pin to a lift base;

FIG. 7 illustrates a lift base in accordance with the present invention; and

FIG. 8 illustrates how a lift pin may be removed and mounted from a lift base in accordance with the present invention.

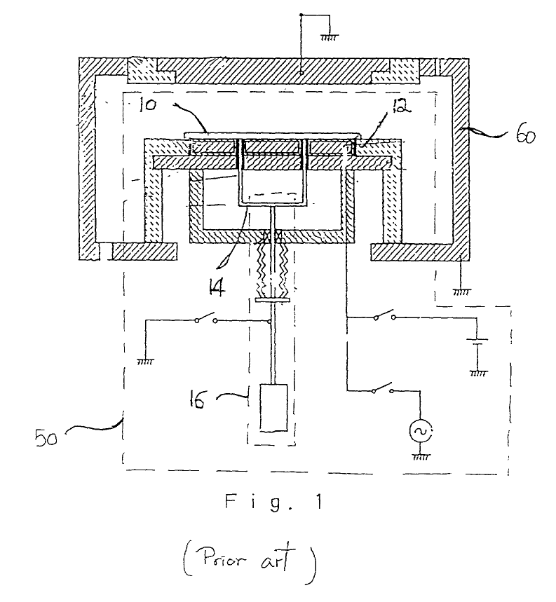

### DETAILED DESCRIPTION OF THE PREFERRED EMBODIMENTS

The present invention provides a chuck system for a semiconductor fabrication process to support a semiconductor wafer and a method of maintaining the chuck system. The present invention generally provides a removable lift pin that can be easily removed and replaced. As a result, the chuck system and method of the present invention minimizes the time required to maintain and replace a chuck system therefore improving productivity of the related equipment and the entire product line.

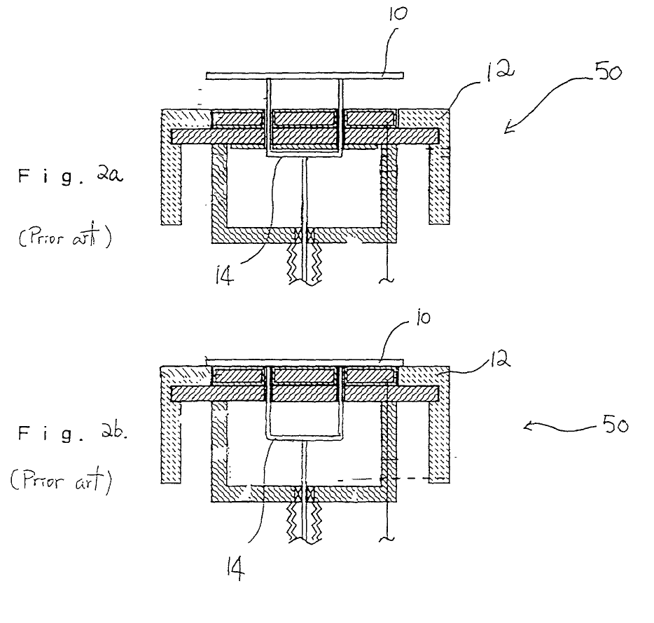

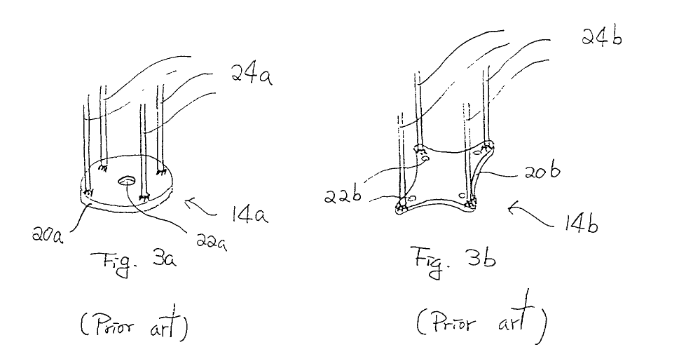

FIG. 4 illustrates a chuck system in accordance with the present invention. Referring to FIG. 4, there is provided a chuck system 100 to support a semiconductor wafer 110. Chuck system 100 may be an electrostatic chuck system or other types of chuck systems. Chuck system 100 includes a chuck platform 112 that provides a surface to support wafer 110, and a lift structure 114 movably coupled with chuck platform 112. Lift structure 114 supports wafer 10, preferably from the non-device side, to place wafer 110 on or away from chuck platform 112. As illustrated in FIGS. 2a and 2b, lift structure 114 of the present invention operates to primarily serve two purposes. The first purpose is to receive wafer 110 when wafer 110 is brought into a processing chamber 160 and place wafer 110 on platform 112. The second purpose is to lift wafer 110 away from platform 112 after wafer process is completed and remove wafer 110 from processing chamber 160.

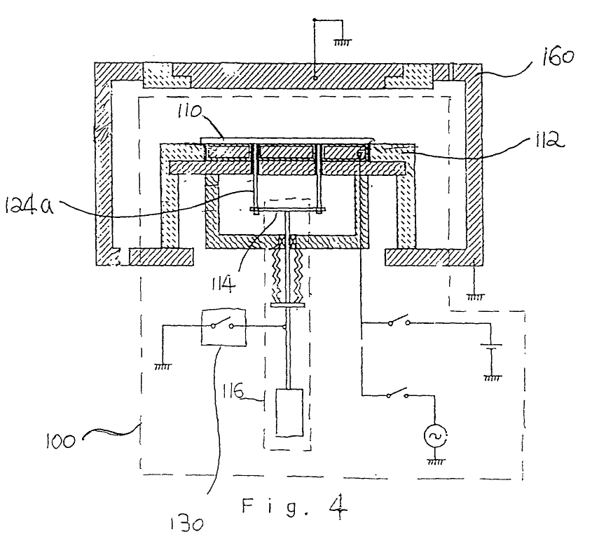

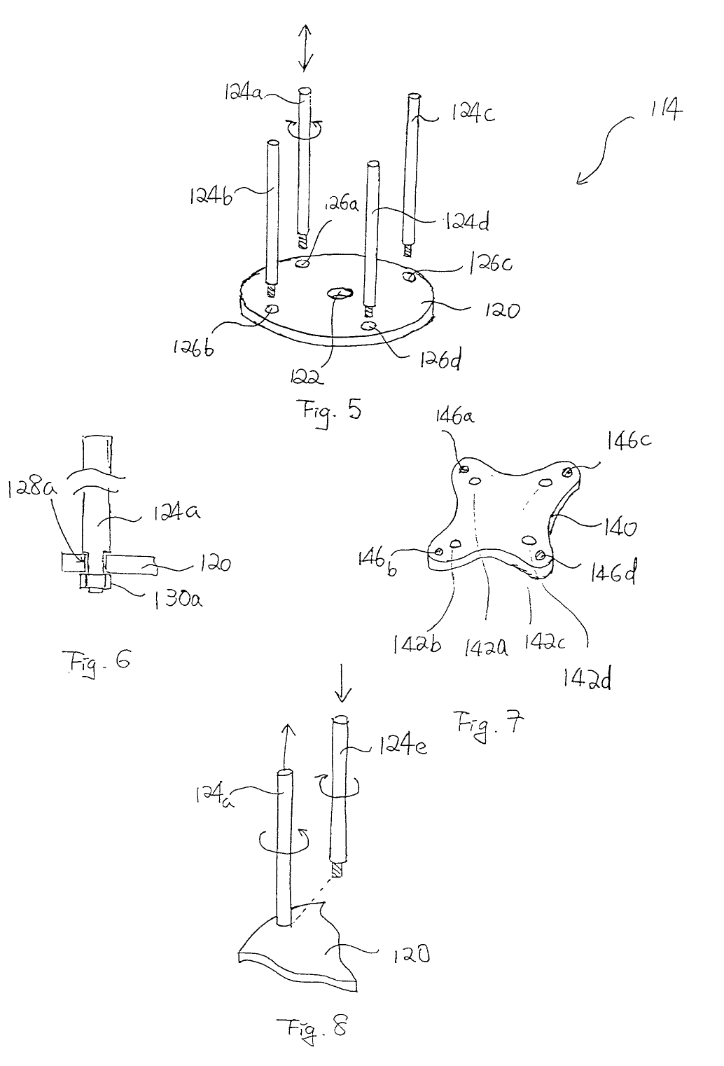

FIG. 5 illustrates an embodiment of lift structure 114 in accordance with the present invention. Referring to FIG. 5, lift structure 114 includes a lift base 120 for receiving lift pins 124a, 124b, 124c, and 124d. The number of lift pins used depends on the design of a chuck system and should not be construed to limit the scope of the present invention. As an example, lift pin 124a is removably coupled with lift base 120. One end of lift pin 124a is connected with lift base 120 and the other end of lift pin 124a is used to support wafer 110 during the lifting and placing operations of lift structure 120 to either lift wafer 110 away from platform 112 or place wafer 110 on platform 112 as shown in FIG. 4. Lift pins 124b, 124c, and 124d may be formed similarly as lift pin 124a to be removably coupled with lift base 120.

In one embodiment of the present invention, lift pin 124a has a threaded end and lift base 120 of lift structure 114 includes a hole 126a to receive the threaded end of lift pin 124a. Therefore, as shown in FIG. 5, lift pin 124a can be mounted to or removed from lift base 120 by rotating lift pin 124.

FIG. 6 illustrates another embodiment of the present invention. Referring to FIG. 6, lift structure 114 may additionally include a bolt 130a having a matching internal thread to removably secure lift pin 124a to lift base 120 through an opening 128a. Bolt 130a may be fixed at the bottom of lift base 120 such that lift pin 124a may be removed or secured to lift base 120 without the need of holding bolt 130a. Lift pin 124a and hole 126a shown in FIG. 5, or bolt 130a shown in FIG. 6 may have more than one set of threads so long as the threads on lift pin 124a and inside hole 126a or bolt 130a are matching.

The lift pins may be made of a variety of materials so long as they provide sufficient support to receive or lift a semiconductor wafer during the placing or lifting operations. Preferably, the present invention has a lift pin made of a conductive material, such as stainless steel or other metals, for the application in an electrostatic chucking system. One purpose of having a conductive lift pin is that a lift structure can help discharging electrostatic charges on a semiconductor wafer when the lift structure is operated to lift the wafer away from the platform. Accordingly, referring to FIG. 4, chuck system 100 may additionally include a grounding device 130 that is conductively coupled to lift structure 114 or lift pin 124a. Grounding device 130 provides a path to discharge electrostatic charges on wafer 110, during wafer-lifting or wafer-placing operation.

Grounding device 130 can conductively couple lift pin 124a to an electrically grounded end when lift structure 114 moves upward to lift wafer 110 away from chuck platform 112, or when lift structure 114 receives wafer 110 when wafer 110 is brought into processing chamber 160. The grounding process helps to remove electrostatic charges on wafer 110 and eliminates unwanted electrostatic charges between wafer 110 and platform 112 during the lifting and placing operations. Referring again to FIG. 5, lift base 120 may be substantially circular and flat, and includes openings 126a, 126b, 126c, 126d respectively for mounting lift pins 124a, 124b, 124c, and 124d. Lift base 120 also includes a mounting hole 122 to mount the entire lift structure 114 to driving mechanism 116 shown in FIG. 4.

Referring to FIG. 7, lift base 140 is nearly-rectangular and includes holes 146a, 146b, 146c, and 146d for mounting four lift pins. Lift base 140 also has four mountings holes 142a, 142b, 142c, and 142d to mount the lift base to driving mechanism 116 shown in FIG. 4.

Referring to FIG. 4, lift structure 114, after numerous operations under harsh temperatures and atmospheric pressures of processing chamber 160, often develops defects such as deformation of one or more of the lift pins. Pin deformation will cause imbalance or inaccuracy in placing or lifting wafer 110. An operation under a defective lift pin will cause damage to wafers or the electrostatic chuck system itself. Under the design of traditional chuck systems, the entire lift structure 114 needs to be replaced. The present invention provides removable lift pins thereby obviating the need to replace the entire lift structure.

The present invention also provides a method of maintaining a lifting structure of a chuck system. Referring to FIG. 5, the method applies to lift structure 114 that includes a lift base 120 and a lift pin 124a, or preferably, a plurality of lift pins 124a, 124b, 124c, and 124d. Referring to FIG. 8, the method includes dismounting lift pin 124a from lift base 120 without removing the entire lift structure 114 from chuck system 100. The method also includes mounting a replacing lift pin 124e in FIG. 8 without removing the entire lift structure 114 from chuck system 100. Because lift pin 124a is removably mounted to lift base 120, lift pin 124a can be replaced by lift pin 124e without changing lift base 120.

Chuck system 100 may also include a cooling system and a control system under chuck platform 112. In traditional replacement procedures, liquid circulating in the chuck system 100 will need to be removed together with several other components. These processes usually take time and make processing chamber 160 unavailable for production.

The method of the present invention is able to replace lift pin 124a without removing other parts or liquid in chuck system 100. The method, therefore, reduces the cost and time associated with lift-pin replacement operations and increase productivity by improving upon the traditional lift-base design and chuck system maintenance procedure.

It will be apparent to those skilled in the art that various modifications and variations can be made in the disclosed system and method without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A chuck system for supporting a semiconductor wafer, comprising:
a chuck platform for supporting the semiconductor wafer; and
a lift structure movably coupled with the chuck platform to receive the semiconductor wafer, including
a lift base, and
at least one lift pin removably coupled with the lift base, the lift pin having two ends with a first end removably coupled to the lift base and a second end for supporting the semiconductor wafer during lifting operation of the lift structure.

2. The chuck system as claimed in claim 1, wherein the first end of the lift pin is threaded and the lift base having a threaded hole for receiving the first end of the lift pin.

3. The chuck system as claimed in claim 1 further comprising a bolt, wherein the first end of the lift pin is threaded and the bolt removably couples the lift pin with the lift base through an opening provided by the lift base.

4. The chuck system as claimed in claim 1, wherein the lift structure comprises a plurality of lift pins coupled to the lift base.

5. The chuck system as claimed in claim 1, wherein the lift pin is made of a conductive material.

6. The chuck system as claimed in claim 1, wherein the chuck system is an electrostatic chuck system.

7. The chuck system as claimed in claim 1, wherein the lift pin is conductively coupled to an electrically grounded end when the lift structure moves to lift the semiconductor wafer away from the chuck platform.

8. The chuck system as claimed in claim 1, wherein the lift pin is conductively coupled to an electrically grounded end when the lift structure receives the semiconductor wafer to place the wafer on the chuck platform.

9. The chuck system as claimed in claim 1, wherein the lift base is substantially flat and provides a least one opening for receiving the at least one lift pin.

10. A chuck system for supporting a semiconductor wafer, comprising:
a chuck platform for providing support of the semiconductor wafer;
a lift structure movably coupled with the chuck platform for supporting the semiconductor wafer to receive or place the semiconductor wafer on the chuck platform or to lift the wafer away from the chuck platform, the lift structure including
a lift pin, and
a lift base for supporting the lift pin,
wherein the lift pin has two ends, the lift pin being removably coupled with the lift base, a first end of the lift pin being connected with the lift base, and a second end of the lift pin supporting the semiconductor wafer during lifting or placing operation of the lift structure, and
wherein the lift structure has an external thread on the first end of the lift pin and a matching internal thread in a hole provided by the lift base to removably couple the lift pin and the lift base.

11. The chuck system as claimed in claim 10, wherein the lift structure has a plurality of lift pins coupled to the lift base.

12. The chuck system as claimed in claim 10, wherein the lift pin is made of a conductive material.

13. The chuck system as claimed in claim 10, wherein the chuck system is an electrostatic chuck system.

14. The chuck system as claimed in claim 10, wherein the lift pin is conductively coupled to an electrically grounded end when the lift structure moves to lift the wafer away from the chuck platform.

15. The chuck system as claimed in claim 10, wherein the lift pin is conductively coupled to an electrically grounded end when the lift structure receives the wafer to place the wafer on the chuck platform.

16. The chuck system as claimed in claim 10 further comprising a bolt, wherein the first end of the lift pin is threaded and the bolt removably couples the lift pin with the lift base.

17. A method of maintaining a lift structure of a chuck system that supports a semiconductor wafer, comprising:
providing a removable first lift pin to a lift base in the lift structure;
removing the first lift pin from the lift base with the lift structure being coupled to the chuck system; and
mounting a second lift pin to the lift base with the lift structure being coupled to the chuck system.

18. The method of maintaining the lift structure as claimed in claim 17, wherein the first lift pin is removed from and the second lift pin is mounted to a same lift base with the same lift base being coupled to the lift structure.
